(19) United States
(12) Patent Application Publication
(10) Pub. No.: US 2017/0371955 A1
(43) Pub. Date: Dec. 28, 2017

(54) SYSTEM AND METHOD FOR PRECISE DOMAIN QUESTION AND ANSWER GENERATION FOR USE AS GROUND TRUTH

(71) Applicant: International Business Machines Corporation, Armonk, NY (US)

(72) Inventors: Corville O. Allen, Morrisville, NC (US); Andrew R. Freed, Cary, NC (US); Rajesh P. Ramachandran, Fremont, CA (US)

(21) Appl. No.: 15/190,860

(22) Filed: Jun. 23, 2016

(51) Int. Cl. G06F 17/30

(52) U.S. Cl. CPC G06F 17/30684; G06F 17/30654

(57) ABSTRACT

Embodiments provide a system and method for question and answer (QA) generation. Using a cognitive system having natural language processing capabilities, the QA generation system can analyze a corpus of documents, which can each have one or more headings, sub-headings, and fact statements. By analyzing the structural relationships of the one or more headings, the QA generation system can score each fact statement against the headings to score the one or more facts for use as ground truths. Strong facts, with multiple relationships to the one or more headings, can serve as the primary basis for the ground truth established for a particular knowledge domain or sub-domain. Facts can be scored based on their lexical answer type score, their header relevance score, their relationship score, their structure score, and their domain header relevance score.

### TECHNICAL FIELD

The present application relates generally to a system and method that can be used to generate question and answer pairs precisely based on a particular knowledge domain or sub-domain.

### BACKGROUND

Questions and answer (QA) generation systems rely on a broad and diverse repository of information from which questions and answers are generated. Typically, the repository can include collections of imported documents or other materials that are parsed and analyzed to create question and answer pairs for analysis by the overall QA system. However, those materials, even when ostensibly limited to a particular subject matter domain, may contain ancillary sentences and information that may be partially or wholly unrelated to the domain's concepts, issues, or main concerns as they relate to QA systems.

Traditional QA generation from materials with extraneous information results in many irrelevant questions to the domain, which would require manual removal from the total set of questions generated. However, in order for the more rapid and accurate functioning of a QA system, QA pairs or facts must be more precisely chosen in order to better comprise a mastery of the material relevant to the domain, rather than extracting an overly large set of facts or QA pairs and assuming that every fact or QA pair deserve equal weight, and to preclude the need for the time and resource consuming process of manually pruning extraneous questions from the QA set.

### SUMMARY

Embodiments can provide a computer implemented method, in a data processing system comprising a processor and a memory comprising instructions which are executed by the processor to cause the processor to implement a question and answer generation system, the method comprising ingesting a corpus comprising one or more documents comprising one or more headings and one or more fact statements; utilizing natural language processing to analyze the corpus against a domain of knowledge; denoting the one or more headings; extracting the one or more fact statements; analyzing each fact statement for relevance relating to the one or more headings and the domain; scoring each fact statement based upon one or more weighting calculations; and extracting one or more strong facts for use as ground truth in the domain.

Embodiments can further provide a method further comprising upon ingestion, performing anaphoric resolution of each document.

Embodiments can further provide a method wherein the anaphoric resolution is performed at the paragraph level.

Embodiments can further provide a method further comprising creating a tree model of the one or more headings and one or more fact statements.

Embodiments can further provide a method further comprising scoring each fact statement based upon its relationship to the one or more headings.

Embodiments can further provide a method further comprising utilizing a training model to recursively examine and weigh each fact statement according to one or more characteristics.

Embodiments can further provide a method further comprising scoring each fact statement by multiplying the fact statement's lexical answer type score by the sum of its header relevance score, relationship score, and structure score, further multiplied by its domain header relevance score.

Embodiments can further provide a method further comprising determining each fact statement's header relevance score by dividing a sum of the number of terms relevant to a particular header, a number of relevant types to the header, and a number of relevant siblings, by a sum of the number of terms in the fact statement.

Embodiments can further provide a method further comprising determining each fact statement's relationship score by multiplying a number of relevant relationships in the fact statement by the weighting of one or more domain relationships.

Embodiments can further provide a method further comprising determining each fact statement's structure score by multiplying the quotient of the fact statement's structure content by the number of different structure types by the domain relevant structures.

In another illustrative embodiment, a computer program product comprising a computer usable or readable medium having a computer readable program is provided. The computer readable program, when executed on a processor, causes the processor to perform various ones of, and combinations of, the operations outlined above with regard to the method illustrative embodiment.

In yet another illustrative embodiment, a system is provided. The system may comprise a QA generation processor configured to perform various ones of, and combinations of, the operations outlined above with regard to the method illustrative embodiment.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 depicts a schematic diagram of one illustrative embodiment of a cognitive system implementing a question and answer (QA) generation system in a computer network;

FIG. 2 is a block diagram of an example data processing system in which aspects of the illustrative embodiments are implemented;

FIG. 3 illustrates a QA system pipeline, of a cognitive system, for processing an input question generated from the QA generation system in accordance with one illustrative embodiment;

FIG. 4 illustrates example mapping of document structure in accordance with illustrative embodiments described herein;

FIG. 5 illustrates an example acyclic graph (tree model) using the document structure mapping according to the illustrative embodiments;

FIG. 6 illustrates a sample document for ingestion by the QA generation system in accordance with illustrative embodiments described herein; and

FIG. 7 illustrates a sample analysis of the facts extracted from the sample document as shown in FIG. 6, in accordance with illustrative embodiments described herein.

### DETAILED DESCRIPTION OF EXEMPLARY EMBODIMENTS

The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a head disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-along software package, partly on the user's computer and partly on a remote computer, or entirely on the remote computer or server. In the latter scenario, the remote computer may be connected to the user's computer through any type of network, including LAN or WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. IBM Watson™ is an example of one such cognitive system which can process human readable language and identify inferences between text passages with human-like accuracy at speeds far faster than human beings and on a much larger scale. In general, such cognitive systems are able to perform the following functions:
Navigate the complexities of human language and understanding
Ingest and process vast amounts of structured and unstructured data
Generate and evaluate hypotheses
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
High degree of relevant recollection from data points (images, text, voice) (memorization and recall)
Predict and sense with situation awareness that mimic human cognition based on experiences
Answer questions based on natural language and specific evidence

In one aspect, cognitive systems provide mechanisms for answering questions posed to these cognitive systems using a Question Answering pipeline or system (QA system). The QA pipeline or system is an artificial intelligence application executing on data processing hardware that answers questions pertaining to a given subject-matter domain presented in natural language. The QA pipeline receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA pipeline. The document may include any file, text, article, or source of data for use in the QA system. For example, a QA pipeline accesses a body of knowledge about the domain, or subject matter area (e.g., financial domain, medical domain, legal domain, etc.) where the body of knowledge (knowledgebase) can be organized in a variety of configurations, e.g., a structured repository of domain-specific information, such as ontologies, or unstructured data related to the domain, or a collection of natural language documents about the domain.

Content users input questions to the cognitive system which implements the QA pipeline. The QA pipeline then answers the input questions using the content in the corpus or data by evaluating documents, sections of documents, portions of data in the corpus, or the like. When a process evaluates a given section of a document for semantic content, the process can use a variety of conventions to query such document from the QA pipeline, e.g., sending the query to the QA pipeline as a well-formed question which is then interpreted by the QA pipeline and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using natural language processing.

As will be described in greater detail hereafter, the QA pipeline receives an input question, parses the question to extract the major features of the question, uses the extracted features to formulate queries, and then applies those queries to the corpus of data. Based on the application of the queries to the corpus of data, the QA pipeline generates a set of hypotheses, or candidate answers to the input question, by looking across the corpus of data for portions of the corpus of data that have some potential for containing a valuable response to the input question. The QA pipeline then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA pipeline. The statistical model is used to summarize a level of confidence that the QA pipeline has regarding the evidence that the potential response, i.e., candidate answer, is inferred by the question. This process is repeated for each of the candidate answers until the QA pipeline identifies candidate answers that surface as being significantly stronger than others and thus generates a final answer, or ranked set of answers, for the input question.

As mentioned above, QA pipeline and mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e., candidate answers.

Content creators, such as article authors, electronic document creators, web page authors, document database creators, and the like, determine use cases for products, solutions, and services described in such content before writing their content. Consequently, the content creators know what questions the content is intended to answer in a particular topic addressed by the content. Categorizing the questions, such as in terms of roles, type of information, tasks, or the like, associated with the question, in each document of a corpus of data allows the QA pipeline to more quickly and efficiently identity documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA pipeline. Content creators, automated tools, or the like, annotate or otherwise generate metadata for providing information useable by the QA pipeline to identify question and answer attributes of the content.

Operating on such content, the QA pipeline generates answers for input questions using a plurality of intensive analysis mechanisms which evaluate the content to identify the most probable answers, i.e., candidate answers, for the input question. The most probable answers are output as a ranked listing of candidate answers ranked according to their relative scores or confidence measures calculated during evaluation of the candidate answers, as a single final answer having a highest ranking score or confidence measure, or which is a best match to the input question, or a combination of ranked listing and final answer.

A central concept of implementing a question and answer system is to utilize the structure of a document for a particular domain to determine the most useful training facts to extract from the document. The facts pertaining to each heading in a document are scored based on their content by looking at matches to the lexical answer types for the domain, the key terms for the domain, and the relationships and relationship types for the domain across the document's headers. The structure of the content of the facts and their associations with one or more domain headers are utilized to compute a fact score where the highest weighted facts are treated as the most useful to extract.

The structure of the document can be used to determine the most useful training facts to extract from that document. Document structure can highlight important summarization levels (for example, document titles, heading titles, sub-heading titles, etc.) that can help identify core concepts and information contained within the document. By extracting all possible facts from a document, and then ranking each fact by cross-referencing them to ancestor and sibling header information in the document structure, precise questions and answers can be generated. The top ranking facts can become the training set from that document. This can build a more precise and concise set of facts that can cover the broad sections that the author of the document was trying to highlight.

Benefits of the precise question and answer generation system result from the fact that not every fact in a document is important to a particular domain. For instance, in a document representative of a web page, the important content is in the body of the page itself, but not the ads, legal statement, privacy statement, or other boiler plate content. Use of the present question and answer generation system minimizes the number of facts to process when ingesting and identifying content for use, which can allow for fact finding that is better suited for a particular domain or subdomain.

In an illustrative embodiment, documents can be ingested, and the headings and sub-headings can be denoted as well as the information within them. Each child statement or paragraph can be analyzed for relevance to the heading and/or the domain. For each statement or paragraph a check can be made as to whether it contains term types that match the typical lexical answer type for the domain or the heading. Whether the terms in the statements match the header or domain can be determined by exact match, synonyms, or by ontology. The relationship found in the statements can be denoted. The statements can be scored based on a weighted calculation of the previously denoted characteristics. Any statement having a strong score over a pre-determined threshold for a particular domain or heading can be extracted for use as a ground truth or identified as a highly relevant fact.

In an alternate illustrative embodiment, documents can be analyzed by a structure mapping engine (SME), where headers and/or sections can be denoted and given a weight based on relevance to the domain and/or sub-domain. Characteristics of the sections can also be given weights based on how the content and structure of the content is stated. For example, tables and bulleted lists may carry more weight, which graphs carry lower weight. The headers can be given relevance based on the document type and their particular weighting, and these can be applied to the score of an individual fact statement to increase or decrease their domain relevance score. The same can be applied to certain relationship types for a domain. For example, a financial document with statements about results would likely weigh a table in a section as having higher weight thus increasing the statements around that table as relevant for a score. A relationship such as “Company A buys Company B” could be weighted higher for this sub-domain and impact the scores of those facts.

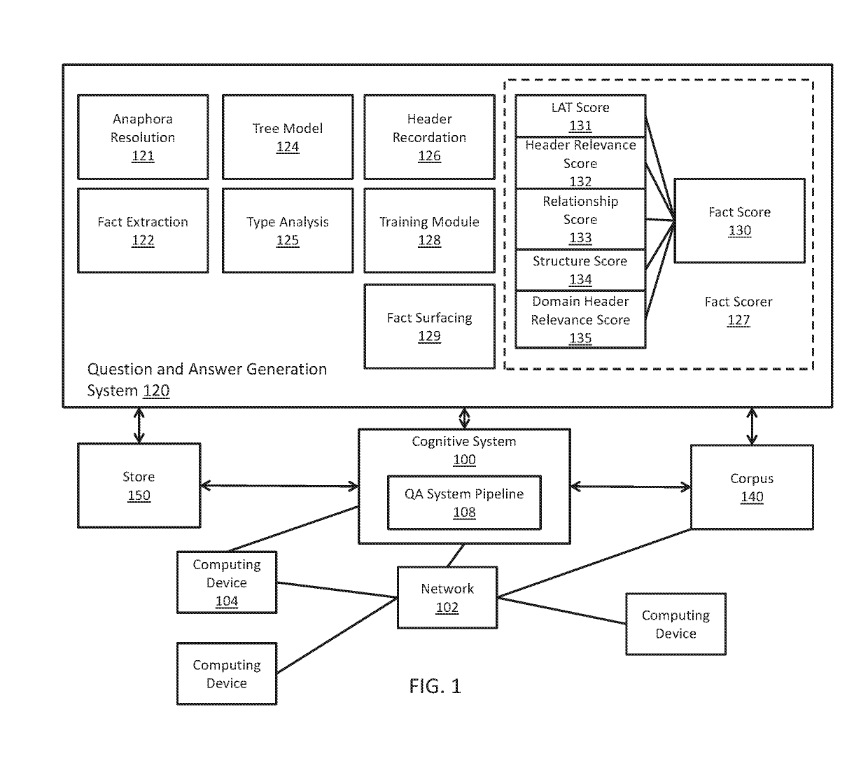

FIG. 1 depicts a schematic diagram of one illustrative embodiment of a cognitive system 100 implementing a question and answer (QA) pipeline 108 in a computer network 102. One example of a question/answer generation operation which may be used in conjunction with the principles described herein is described in U.S. Patent Application Publication No. 2011/0125734, which is herein incorporated by reference in its entirety. The cognitive system 100 is implemented on one or more computing devices 104 (comprising one or more processors and one or more memories, and potentially any other computing device elements generally known in the art including buses, storage devices, communication interfaces, and the like) connected to the computer network 102. The network 102 includes multiple computing devices 104 in communication with each other and with other devices or components via one or more wired and/or wireless data communication links, where each communication link comprises one or more of wires, routers, switches, transmitters, receivers, or the like. The cognitive system 100 and network 102 enables question/answer (QA) generation functionality for one or more cognitive system users via their respective computing devices. Other embodiments of the cognitive system 100 may be used with components, systems, sub-systems, and/or devices other than those that are depicted herein.

The cognitive system 100 is configured to implement a QA pipeline 108 that receive inputs from various sources. For example, the cognitive system 100 receives input from the network 102, a corpus of electronic documents 140, cognitive system users, and/or other data and other possible sources of input. In one embodiment, some or all of the inputs to the cognitive system 100 are routed through the network 102. The various computing devices 104 on the network 102 include access points for content creators and QA system users. Some of the computing devices 104 include devices for a database storing the corpus of data 140. Portions of the corpus of data 140 may also be provided on one or more other network attached storage devices, in one or more databases, or other computing devices not explicitly shown in FIG. 1. The network 102 includes local network connections and remote connections in various embodiments, such that the cognitive system 100 may operate in environments of any size, including local and global, e.g., the Internet.

In one embodiment, the content creator creates content in a document of the corpus of data 140 for use as part of a corpus of data with the cognitive system 100. The document includes any file, text, article, or source of data for use in the cognitive system 100. QA system users access the cognitive system 100 via a network connection or an Internet connection to the network 102, and input questions to the cognitive system 100 that are answered by the content in the corpus of data 140. In one embodiment, the questions are formed using natural language. The cognitive system 100 parses and interprets the question via a QA pipeline 108, and provides a response to the cognitive system user containing one or more answers to the question. In some embodiments, the cognitive system 100 provides a response to users in a ranked list of candidate answers while in other illustrative embodiments, the cognitive system 100 provides a single final answer or a combination of a final answer and ranked listing of other candidate answers.

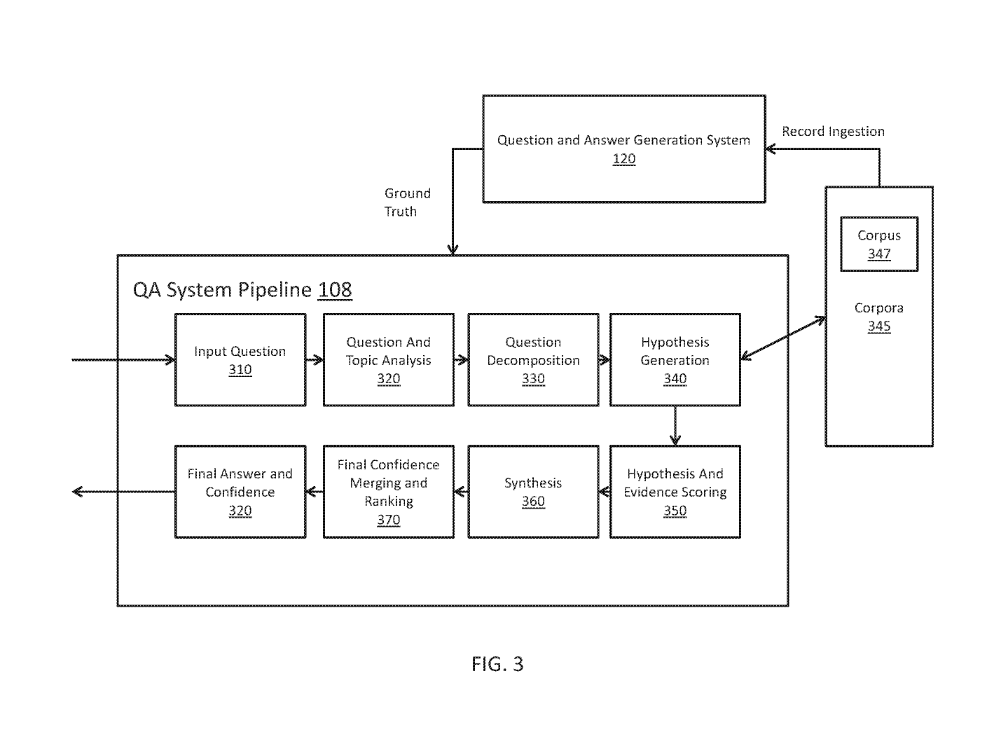

The cognitive system 100 implements the QA pipeline 108 which comprises a plurality of stages for processing an input question and the corpus of data 140. The QA pipeline 108 generates answers for the input question based on the processing of the input question and the corpus of data 140. The QA pipeline 108 will be described in greater detail hereafter with regard to FIG. 3.

In some illustrative embodiments, the cognitive system 100 may be the IBM Watson™ cognitive system available from International Business Machines Corporation of Armonk, N.Y., which is augmented with the mechanisms of the illustrative embodiments described hereafter. As outlined previously, a QA pipeline of the IBM Watson™ cognitive system receives an input question, which it then parses to extract the major features of the question, and which in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The QA pipeline of the IBM Watson™ cognitive system then performs deep analysis on the language of the input question and the language used in each of the portions of the corpus of data found during the application of the queries using a variety of reasoning algorithms. The scores obtained from the various reasoning algorithms are then weighted against a statistical model that summarizes a level of confidence that the QA pipeline of the IBM Watson™ cognitive system has regarding the evidence that the potential response, i.e., candidate answer, is inferred by the question. This process is repeated for each of the candidate answers to generate a ranked listing of candidate answers which may then be presented to the user that submitted the input question, or from which a final answer is selected and presented to the user. More information about the QA pipeline of the IBM Watson™ cognitive system may be obtained, for example, from the IBM Corporation website, IBM Redbooks, and the like. For example, information about the QA pipeline of the IBM Watson™ cognitive system can be found in Yuan et al., “Watson and Healthcare.” IBM developerWorks, 2011 and “The Era of Cognitive Systems: An Inside Look at IBM Watson and How it Works” by Rob High, IBM Redbooks, 2012.

As shown in FIG. 1, in accordance with some illustrative embodiments, the cognitive system 100 is further augmented, in accordance with the mechanisms of the illustrative embodiments, to include logic implemented in specialized hardware, software executed on hardware, or any combination of specialized hardware and software executed on hardware, for implementing a precise question and answer (QA) generation system 120. The operation of the QA generation system 120 may be initiated in response to additional materials being added to the corpus 140 of documents from which the cognitive system 100 interacts with. Alternately, the operation of the QA generation system 120 may be initiated at the behest of a user, or at prescheduled intervals.

In accordance with some illustrative embodiments, the QA generation system 120 can function in the following manner: the QA generation system 120 can ingest one or more documents or other textual materials from the corpus 140 and perform anaphora resolution 121 at the paragraph level. Anaphora resolution 121 can also be referred to as pronoun resolution, which allows for a resolution as to what a pronoun or noun phrase refers through analysis of its antecedent expression. For example, in the phrase, “Brian went to the party, but nobody said hello to him,” the pronoun “him” is the anaphor, and refers back to the antecedent “Brian.” Anaphora resolution 121 can be accomplished by the QA generation system 120 using anaphora resolution algorithms that are standard in the art.

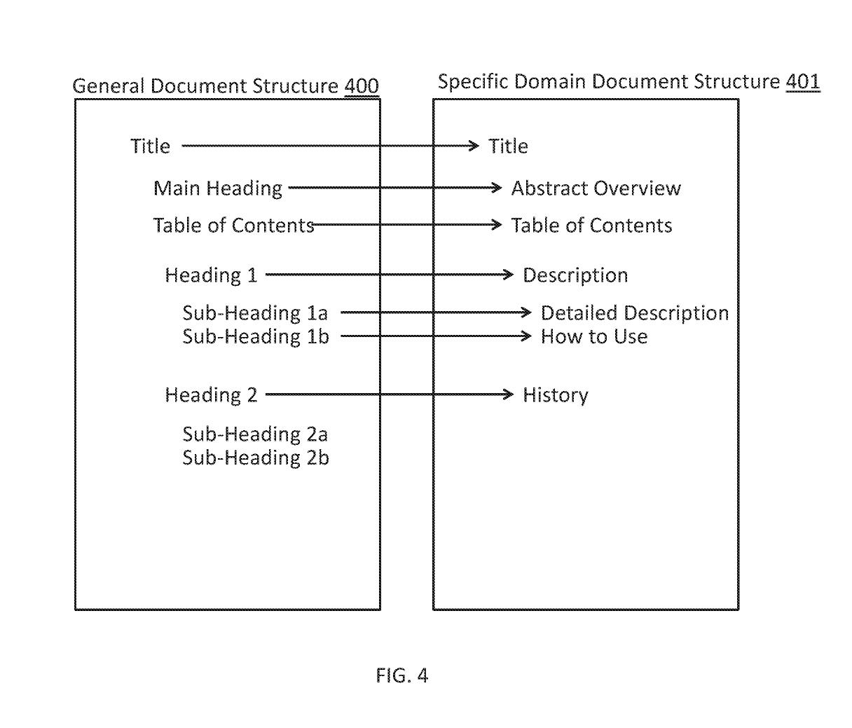

Using the anaphoric resolution 121, the QA generation system can perform a fact extraction 122 to extract as many facts as possible from the document, which can be performed using fact algorithms standard in the art. Concurrently with the fact extraction 122, the question and answer system can create a tree model 124 of the document headers. In an embodiment, the tree model 124 can have a root node being the document title and child nodes being sub-headings. The creation of the tree model will be described further in FIG. 4. Once the tree model 124 is created, the question and answer system can perform a type analysis 125 of each header and interaction between the types. Examples of types can include, but are not limited to: person, location, date, and location/date pairs.

In an embodiment, for every fact extracted, whether directly or through inference, the QA generation system 120 can perform a header recordation 126 to record the header that was a direct parent to the particular fact. The QA generation system 120 can perform a type analysis 125 of the fact and the interactions between the types. The QA generation system can score each fact through a fact scorer 127. Each fact can be scored by comparing how the fact matches to the types/relationships of every ancestor heading. Additionally, each fact can be scored by comparing how the fact matches to the types/relationships of every sibling heading.

The QA generation system 120 can have a training module 128 that can look at a multitude of characteristics. These characteristics can include, but are not limited to, the lexical answer type of the highest value QA pairs as one particular weight, the top number of terms for the domain or sub-domain, the top headers sorted by relevance by keyword and/or header names, the relationship types and existence between key terms and key relationships, the relationships of facts in a single document compared to the fact relevance to other facts, and the statement and sentence structures in a section (such as bulleted lists, tables, sentences, and in-line bullets).

The QA generation system 120 can perform fact surfacing 129 by valuing the highest scored facts (scored by the fact scorer 127) as the most important. The number of highest scored facts can be predetermined by the system. In an embodiment, a fact scorer 127 can create a fact score 130 for each extracted fact. The overall fact score can be the lexical answer type (LAT) score 131, multiplied by the sum of the header relevance score 132, the relationship score 133, and the structure score 134, and further multiplied by the domain header relevance score 135. The header relevance score 132 can be determined by dividing the sum of the number of terms relevant to the header, the number of relevant types to the header, and the number of relevant siblings, by the number of terms in the statement. The relationship score 133 can be determined by multiplying the number of relevant relationships in the statement by the weighting of important domain relationships. The structure score 134 can be determined by multiplying the quotient of the statement structure content divided by the number of structure types by the domain relevant structures.

The domain header relevance score 135 can be a weighting decided based on structure mapping engine (SME) input, which can analyze a document and determine whether certain headers are more relevant. For example, for financial forms such as a SEC 8-K form, headers such as “Final Exhibit,” “Exhibit Statements,” and “Summary” can be deemed as more important than other headers and given greater weight. Similarly in academic or scientific research papers, headings such as “Results,” “Findings,” and “Conclusions” can be given greater weight.

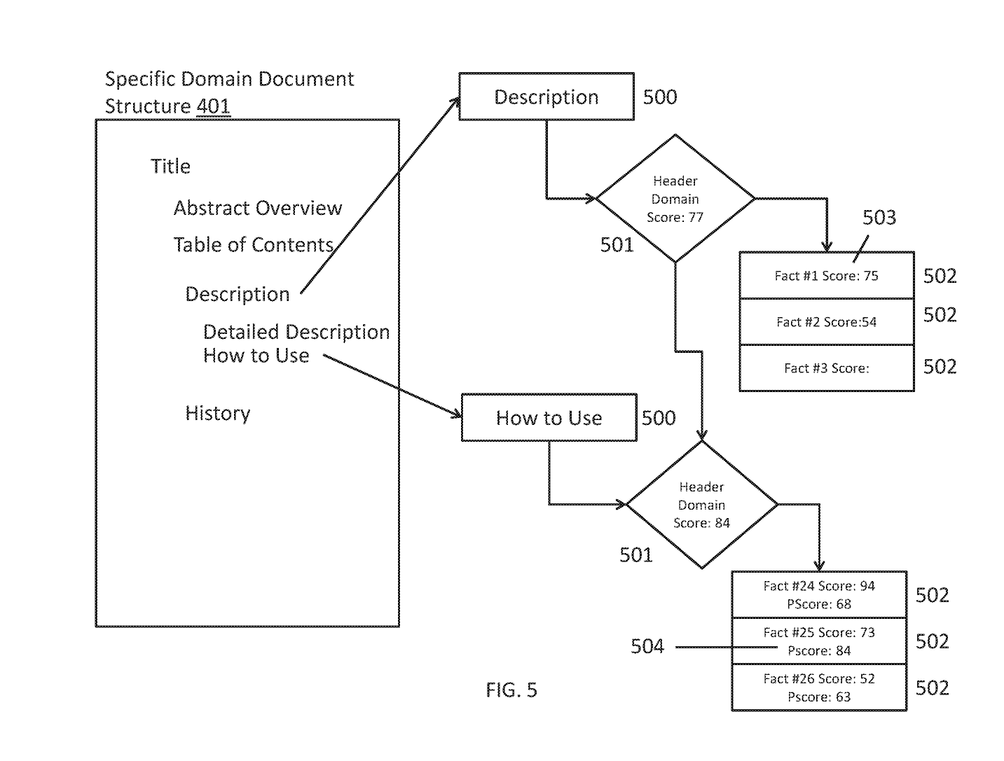

As further described in FIG. 5, one or more documents in a corpus 140 can be subjected to natural language processing techniques of the cognitive system 100 and/or QA generation system to transform the documents into acyclic graphs where nodes represent headers and facts, and connectors represent the overall connections between the various headings and sub-headings. This operation may be performed, for example, as part of an ingestion operation of the cognitive system 100 which reads the natural language text of the electronic documents in the corpus 140, parses the natural language text and performs natural language processing on the natural language text, including performing annotation operations using annotators, to extract key features and facts of the natural language text which are then converted to the acyclic graphs of the various documents in the corpus 140.

The acyclic graphs of the analyzed documents ingested from the corpus 140 are stored in storage device 150 associated with either the cognitive system 100 or the QA generation system 120, where the storage device 150 may be a memory, a hard disk based storage device, flash memory, solid state storage device, or the like (hereafter assumed to be a “memory” with in-memory representations of the acyclic graphs for purposes of description).

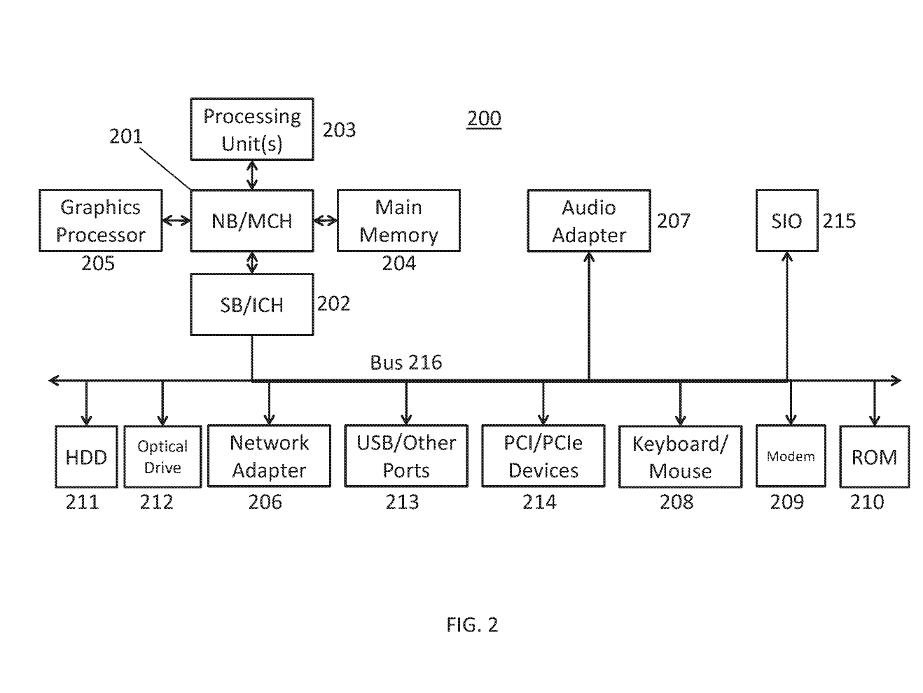

FIG. 2 is a block diagram of an example data processing system 200 in which aspects of the illustrative embodiments are implemented. Data processing system 200 is an example of a computer, such as a server or client, in which computer usable code or instructions implementing the process for illustrative embodiments of the present invention are located. In one embodiment, FIG. 2 represents a server computing device, such as a server, which implements the QA generation system 120 and cognitive system 100 described herein.

In the depicted example, data processing system 200 can employ a hub architecture including a north bridge and memory controller hub (NB/MCH) 201 and south bridge and input/output (I/O) controller hub (SB/ICH) 202. Processing unit 203, main memory 204, and graphics processor 205 can be connected to the NB/MCH 201. Graphics processor 205 can be connected to the NB/MCH through an accelerated graphics port (AGP).

In the depicted example, the network adapter 206 connects to the SB/ICH 202. The audio adapter 207, keyboard and mouse adapter 208, modem 209, read only memory (ROM) 210, hard disk drive (HDD) 211, optical drive (CD or DVD) 212, universal serial bus (USB) ports and other communication ports 213, and the PCl/PCIe devices 214 can connect to the SB/ICH 202 through bus system 216. PCl/PCIe devices 214 may include Ethernet adapters, add-in cards, and PC cards for notebook computers. ROM 210 may be, for example, a flash basic input/output system (BIOS). The HDD 211 and optical drive 212 can use an integrated drive electronics (IDE) or serial advanced technology attachment (SATA) interface. The super I/O (SIO) device 215 can be connected to the SB/ICH.

An operating system can run on processing unit 203. The operating system can coordinate and provide control of various components within the data processing system 200. As a client, the operating system can be a commercially available operating system. An object-oriented programming system, such as the Java™ programming system, may run in conjunction with the operating system and provide calls to the operating system from the object-oriented programs or applications executing on the data processing system 200. As a server, the data processing system 200 can be an IBM® eServer System p® running the

Advanced Interactive Executive operating system or the Linux operating system. The data processing system 200 can be a symmetric multiprocessor (SMP) system that can include a plurality of processors in the processing unit 203. Alternatively, a single processor system may be employed.

Instructions for the operating system, the object-oriented programming system, and applications or programs are located on storage devices, such as the HDD 211, and are loaded into the main memory 204 for execution by the processing unit 203. The processes for embodiments of the QA generation system can be performed by the processing unit 203 using computer usable program code, which can be located in a memory such as, for example, main memory 204, ROM 210, or in one or more peripheral devices.

A bus system 216 can be comprised of one or more busses. The bus system 216 can be implemented using any type of communication fabric or architecture that can provide for a transfer of data between different components or devices attached to the fabric or architecture. A communication unit such as the modem 209 or network adapter 206 can include one or more devices that can be used to transmit and receive data.

Those of ordinary skill in the art will appreciate that the hardware depicted in FIG. 2 may vary depending on the implementation. Other internal hardware or peripheral devices, such as flash memory, equivalent non-volatile memory, or optical disk drives may be used in addition to or in place of the hardware depicted. Moreover, the data processing system 200 can take the form of any of a number of different data processing systems, including but not limited to, client computing devices, server computing devices, tablet computers, laptop computers, telephone or other communication devices, personal digital assistants, and the like. Essentially, data processing system 200 can be any known or later developed data processing system without architectural limitation.

FIG. 3 illustrates a QA system pipeline, of a cognitive system, for processing an input question in accordance with one illustrative embodiment. The QA system pipeline of FIG. 3 may be implemented, for example, as QA pipeline 108 of cognitive system 100 in FIG. 1. It should be appreciated that the stages of the QA pipeline shown in FIG. 3 are implemented as one or more software engines, components, or the like, which are configured with logic for implementing the functionality attributed to the particular stage. Each stage is implemented using one or more of such software engines, components or the like. The software engines, components, etc., are executed on one or more processors of one or more data processing systems or devices and utilize or operate on data stored in one or more data storage devices, memories, or the like, on one or more of the data processing systems. The QA pipeline of FIG. 3 is augmented, for example, in one or more of the stages to implement the improved mechanism of the illustrative embodiments described hereafter, additional stages may be provided to implement the improved mechanism, or separate logic from the pipeline 108 may be provided for interfacing with the pipeline 108 and implementing the improved functionality and operations of the illustrative embodiments.

As shown in FIG. 3, the QA pipeline 108 comprises a plurality of stages 310-380 through which the cognitive system operates to analyze an input question and generate a final response. In an initial question input stage 310, the QA pipeline 108 receives an input question that is presented in a natural language format. That is, a user inputs, via a user interface, an input question for which the user wishes to obtain an answer, e.g., “Who are Washington's closest advisors?” In response to receiving the input question, the next stage of the QA pipeline 108, i.e., the question and topic analysis stage 320, parses the input question using natural language processing (NLP) techniques to extract major features from the input question, and classify the major features according to types, e.g., names, dates, or any of a plethora of other defined topics. For example, in the example question above, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic.

In addition, the extracted major features include key words and phrases classified into question characteristics, such as the focus of the question, the lexical answer type (LAT) of the question, and the like. As referenced to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “drug” since if this word were replaced with the answer, e.g., “Adderall,” the answer can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 3, the identified major features are then used during the question decomposition stage 330 to decompose the question into one or more queries that are applied to the corpora of data/information 345 in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information 345. That is, these various sources themselves, different collections of sources, and the like, represent a different corpus 347 within the corpora 345. There may be different corpora 347 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus 347 within the corpora 345.

The queries are applied to one or more databases storing information about the electronic texts, documents, articles, websites, and the like, that make up the corpus of data/information, e.g., the corpus of data 140 in FIG. 1. The queries are applied to the corpus of data/information at the hypothesis generation stage 340 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 340, to generate hypotheses for answering the input question. These hypotheses are also referred to herein as “candidate answers” for the input question. For any input question, at this stage 340, there may be hundreds of hypotheses or candidate answers generated that may need to be evaluated.

The QA pipeline 108, in stage 350, then performs a deep analysis and comparison of the language of the input question and the language of each hypothesis or “candidate answer,” as well as performs evidence scoring to evaluate the likelihood that the particular hypothesis is a correct answer for the input question. As described in FIG. 1, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e., a measure of confidence in the hypothesis. There are various ways of generating such scores depending upon the particular analysis being performed. In general, however, these algorithms look for particular terms, phrases, or patterns of text that are indicative of terms, phrases, or patterns of interest and determine a degree of matching with higher degrees of matching being given relatively higher scores than lower degrees of matching.

In the synthesis stage 360, the large number of scores generated by the various reasoning algorithms are synthesized into confidence scores or confidence measures for the various hypotheses. This process involves applying weights to the various scores, where the weights have been determined through training of the statistical model employed by the QA pipeline 108 and/or dynamically updated. For example, the weights for scores generated by algorithms that identify exactly matching terms and synonyms may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA pipeline 108 that identifies a manner by which these scores may be combined to generate a confidence score or measure for the individual hypotheses or candidate answers. This confidence score or measure summarizes the level of confidence that the QA pipeline 108 has about the evidence that the candidate answer is inferred by the input question, i.e., that the candidate answer is the correct answer for the input question.

The resulting confidence scores or measures are processed by a final confidence merging and ranking stage 370 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 380, a final answer and confidence score, or final set of candidate answers and confidence scores, are generated and output to the submitter of the original input question via a graphical user interface or other mechanism for outputting information.

FIG. 4 illustrates an example of mapping document structure, according to embodiments described herein. The QA generation system can utilize a general document structure 400 format as a guide by which various types of documents are analyzed. Each heading and sub-heading subgroup can be used to generate the nodes used in the acyclic graphs for use during fact scoring. As shown in FIG. 4, the specific domain document structure 401 is similar the document structure found in online encyclopedia articles, such as Wikipedia articles. General categories such as “Title,” “Main Heading,” “Table of Contents,” “Heading 1,” and “Heading 2” can demark their counterparts (“Title,” “Abstract Overview,” “Table of Contents,” “Description,” and “History”, respectively) in the specific domain document structure 401.

FIG. 5 illustrates an example acyclic graph (tree model) using the specific domain document structure 401 as shown in FIG. 4. As the document is analyzed by the QA generation system, the system can generate one or more nodes 500 corresponding to the one or more headings denoted in the particular document being analyzed. In addition to node 500 creation, the acyclic graph can include header domain score elements 501, which can represent the calculated cumulative score of the set of facts under the particular header for the specific domain. As the QA generation system extracts one or more facts 502 from the document being analyzed, the QA generation system can score the facts along different criteria. A primary score 503 can represent the score of the fact 502 itself in relation to its current header. A PScore 504 can be the score of the fact itself in relation to its ancestor header. In an embodiment, facts 502 extracted under primary headings will not have a PScore 504, as they lack ancestor headers. Through aggregation of the primary scores 503, header domain score elements 501, and PScores 504, the QA generation system can parse and analyze a particular document for its most salient facts, which can be input into the overall cognitive system to generate the ground truths for a particular domain or sub-domain, according to embodiments described above.

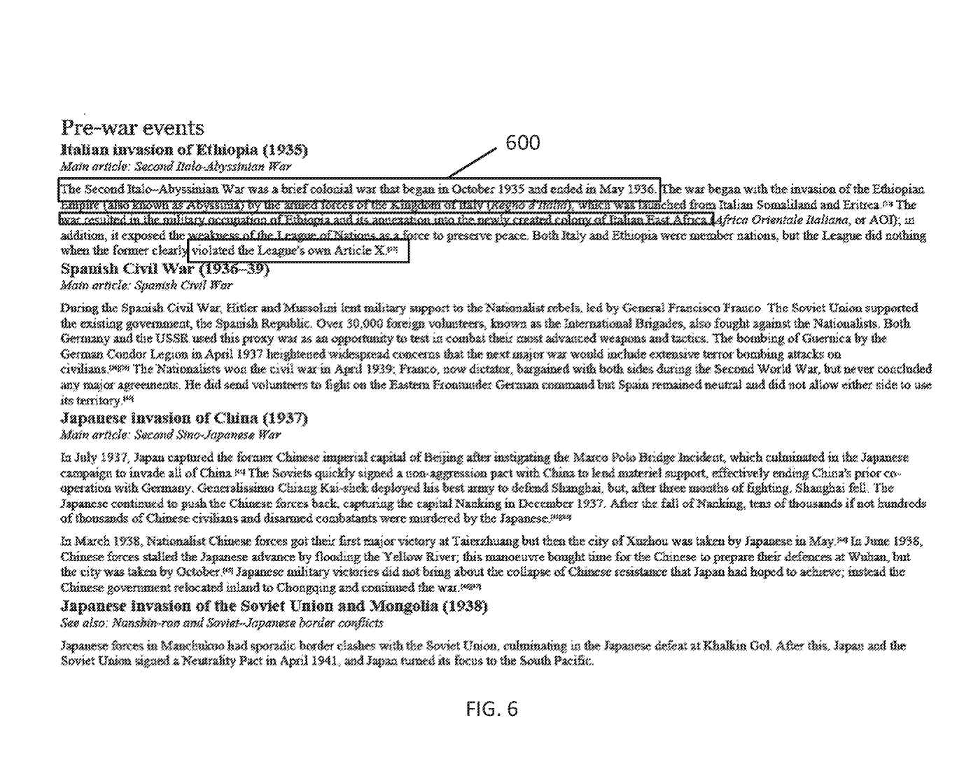

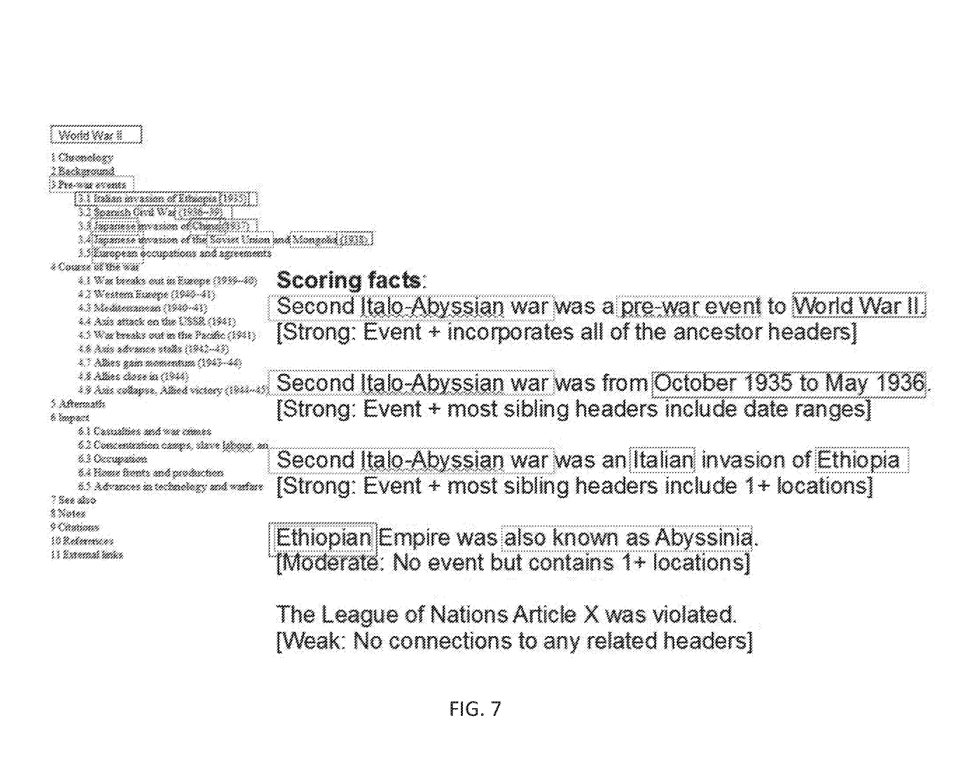

FIGS. 6 and 7 illustrate an example of fact scoring according to embodiments as described herein. Taking the example of analysis by the QA generation system of a Wikipedia article concerning the domain of World War II, the system parses document text, as shown in FIG. 6, and extracts one or more facts 600. While the general domain can be classified as “World War II,” a subdomain within the domain can be classified as the “Italian invasion of Ethiopia.” From within that domain, one or more facts 600 can be extracted, including, “Second Italo-Abyssian war was a pre-war event to World War II,” “Second Italo-Abyssian war was an Italian invasion of Ethiopia,” “Second Italo-Abyssian war was between October 1935 and May 1936,” “Ethiopian Empire was also known as Abyssinia,” and “The League of Nations Article X was violated.” Analysis by the QA generation system as described herein can rank the exemplar facts based on their reference to the antecedent heading and domain information.

“Second Italo-Abyssian war was a pre-war event to World War II” can be classified as a strong fact, as the fact lists an event and incorporates all of the ancestor headers (pre-war, World War II). “Second Italo-Abyssian war was an Italian invasion of Ethiopia” can also be classified as a strong fact as it describes an event, includes one or more sibling headers (Ethiopia, War, Italian), as well as more than one location. “Second Italo-Abyssian war was between October 1935 and May 1936” can also be classified as a strong fact due to it describing an event and including several of its sibling headers (Italian, War) as well as including date ranges. “Ethiopian Empire was also known as Abyssinia” can be classified as a moderate fact as it lacks description of an event but contains one or more locations (Ethiopia, Abyssinia). Lastly, “The League of Nations Article X was violated” can be classified as a weak fact as it lacks any connection to any related headers. According to the illustrative embodiments described herein, the strong facts can be recorded as ground truths of the particular sub-domain as primary returns during QA pipeline retrieval.

The system and processes of the figures are not exclusive. Other systems, processes and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A computer implemented method, in a data processing system comprising a processor and a memory comprising instructions which are executed by the processor to cause the processor to implement a question and answer generation system, the method comprising:
ingesting a corpus comprising one or more documents comprising one or more headings and one or more fact statements;
utilizing natural language processing to analyze the corpus against a domain of knowledge;
denoting the one or more headings;
extracting the one or more fact statements;
analyzing each fact statement for relevance relating to the one or more headings and the domain;
scoring each fact statement based upon one or more weighting calculations; and
extracting one or more strong facts for use as ground truth in the domain.

2. The method as recited in claim 1, further comprising:
upon ingestion, performing anaphoric resolution of each document.

3. The method as recited in claim 2, wherein the anaphoric resolution is performed at the paragraph level.

4. The method as recited in claim 1, further comprising:
creating a tree model of the one or more headings and one or more fact statements.

5. The method as recited in claim 4, further comprising:
scoring each fact statement based upon its relationship to the one or more headings.

6. The method as recited in claim 1, further comprising:
utilizing a training model to recursively examine and weigh each fact statement according to one or more characteristics.

7. The method as recited in claim 1, further comprising:
scoring each fact statement by multiplying the fact statement's lexical answer type score by the sum of its header relevance score, relationship score, and structure score, further multiplied by its domain header relevance score.

8. The method as recited in claim 7, further comprising:
determining each fact statement's header relevance score by dividing a sum of the number of terms relevant to a particular header, a number of relevant types to the header, and a number of relevant siblings, by a sum of the number of terms in the fact statement.

9. The method as recited in claim 7, further comprising:
determining each fact statement's relationship score by multiplying a number of relevant relationships in the fact statement by the weighting of one or more domain relationships.

10. The method as recited in claim 7, further comprising:
determining each fact statement's structure score by multiplying the quotient of the fact statement's structure content by the number of different structure types by the domain relevant structures.

11. A computer program product for question and answer generation, the computer program product comprising a computer readable storage medium having program instructions embodied therewith, the program instructions executable by a processor to cause the processor to:
ingest a corpus comprising one or more documents comprising one or more headings and one or more fact statements;
utilize natural language processing to analyze the corpus against a domain of knowledge;
denote the one or more headings;
extract the one or more fact statements;
analyze each fact statement for relevance relating to the one or more headings and the domain;
score each fact statement based upon one or more weighting calculations; and
extract one or more strong facts for use as ground truth in the domain.

12. The computer program product as recited in claim 11, wherein the processor, upon ingestion, performs anaphoric resolution of each document.

13. The computer program product as recited in claim 11, wherein the processor creates a tree model of the one or more headings and one or more fact statements.

14. The computer program product as recited in claim 13, wherein each fact statement is scored based upon its relationship to the one or more headings.

15. The computer program product as recited in claim 11, wherein a training model is utilized to recursively examine and weigh each fact statement according to one or more characteristics.

16. The computer program product as recited in claim 11, wherein each fact statement is scored by multiplying the fact statement's lexical answer type score by the sum of its header relevance score, relationship score, and structure score.

17. The computer program product as recited in claim 16, wherein each fact statement's header relevance score is determined by dividing a sum of the number of terms relevant to a particular header, a number of relevant types to the header, and a number of relevant siblings, by a sum of the number of terms in the fact statement.

18. The computer program product as recited in claim 16, wherein each fact statement's relationship score is determined by multiplying a number of relevant relationships in the fact statement by the weighting of one or more domain relationships.

19. The computer program product as recited in claim 16, wherein each fact statement's structure score is determined by multiplying the quotient of the fact statement's structure content by the number of different structure types by the domain relevant structures.

20. A system for question and answer generation, comprising:
a question and answer generation processor configured to:
ingest a corpus comprising one or more documents comprising one or more headings and one or more fact statements;
utilize natural language processing to analyze the corpus against a domain of knowledge;
denote the one or more headings;
extract the one or more fact statements;
analyze each fact statement for relevance relating to the one or more headings and the domain;
score each fact statement based upon one or more weighting calculations; and
extract one or more strong facts for use as ground truth in the domain.
